(19) United States
(12) Patent Application Publication
(10) Pub. No.: US 2025/0165544 A1
(43) Pub. Date: May 22, 2025

(54) HIERARCHICAL REPRESENTATION LEARNING OF USER INTEREST

(71) Applicant: Microsoft Technology Licensing, LLC, Redmond, WA (US)

(72) Inventors: Linjun SHOU, Haidian (CN); Xingyao ZHANG, Beijing (CN); Ming GONG, Beijing (CN); Daxin JIANG, Beijing (CN)

(21) Appl. No.: 18/839,396

(22) PCT Filed: Jul. 21, 2022
(86) PCT No.: PCT/US2022/037942

§ 371 Date: Aug. 16, 2024

(30) Foreign Application Priority Data
Sep. 26, 2021 (CN) 202111128750.3

(51) Int. Cl. G06F 16/9535; G06F 16/906; G06N 20/00

(52) U.S. Cl. CPC G06F 16/9535; G06F 16/906; G06N 20/00

(57) ABSTRACT

The present disclosure proposes a method, apparatus and computer program product for hierarchical representation learning of user interest. A historical content item sequence of a user may be obtained. A topic and a text of each historical content item in the historical content item sequence may be identified, to obtain a topic sequence and a text sequence corresponding to the historical content item sequence. A comprehensive topic representation may be generated based on the topic sequence. A comprehensive text representation may be generated based on the text sequence. A user interest representation of the user may be generated based on the comprehensive topic representation and the comprehensive text representation.

### BACKGROUND

With the development of network technology and the growth of network information, recommendation systems are playing increasingly important roles in many online services. Based on different recommended content, there are different recommendation systems, e.g., a news recommendation system, a music recommendation system, a movie recommendation system, a product recommendation system, etc. These recommendation systems usually capture interest of a user, and predict content that the user is interested in according to the interest of the user, and recommend the content to the user.

### SUMMARY

This Summary is provided to introduce a selection of concepts that are further described below in the Detailed Description. It is not intended to identify key features or essential features of the claimed subject matter, nor is it intended to be used to limit the scope of the claimed subject matter. Embodiments of the present disclosure propose a method, apparatus and computer program product for hierarchical representation learning of user interest. A historical content item sequence of a user may be obtained. A topic and a text of each historical content item in the historical content item sequence may be identified, to obtain a topic sequence and a text sequence corresponding to the historical content item sequence. A comprehensive topic representation may be generated based on the topic sequence. A comprehensive text representation may be generated based on the text sequence. A user interest representation of the user may be generated based on the comprehensive topic representation and the comprehensive text representation.

It should be noted that the above one or more aspects comprise the features hereinafter fully described and particularly pointed out in the claims. The following description and the drawings set forth in detail certain illustrative features of the one or more aspects. These features are only indicative of the various ways in which the principles of various aspects may be employed, and this disclosure is intended to include all such aspects and their equivalents.

### BRIEF DESCRIPTION OF THE DRAWINGS

The disclosed aspects will hereinafter be described in connection with the appended drawings that are provided to illustrate and not to limit the disclosed aspects.

FIG. 1 illustrates an exemplary process for hierarchical representation learning of user interest according to an embodiment of the present disclosure.

FIG. 2 illustrates an exemplary topic sequence and a corresponding topic graph according to an embodiment of the present disclosure.

FIG. 3 illustrates an exemplary process for constructing a topic graph according to an embodiment of the present disclosure.

FIG. 4 illustrates an exemplary process for generating a comprehensive topic representation according to an embodiment of the present disclosure.

FIG. 5 illustrates an exemplary process for generating a comprehensive text attention representation according to an embodiment of the present disclosure.

FIG. 6 illustrates an exemplary process for generating a comprehensive text capsule representation according to an embodiment of the present disclosure.

FIG. 7 illustrates an exemplary process for predicting a click probability according to an embodiment of the present disclosure.

FIG. 8 illustrates an exemplary process for training a click probability predicting model according to an embodiment of the present disclosure.

FIG. 9 is a flowchart of an exemplary method for hierarchical representation learning of user interest according to an embodiment of the present disclosure.

FIG. 10 illustrates an exemplary apparatus for hierarchical representation learning of user interest according to an embodiment of the present disclosure.

FIG. 11 illustrates an exemplary apparatus for hierarchical representation learning of user interest according to an embodiment of the present disclosure.

### DETAILED DESCRIPTION

The present disclosure will now be discussed with reference to several example implementations. It is to be understood that these implementations are discussed only for enabling those skilled in the art to better understand and thus implement the embodiments of the present disclosure, rather than suggesting any limitations on the scope of the present disclosure.

In order to enable a recommendation system to predict content that a user is interested in so as to achieve efficient and personalized recommendation, it is necessary to model user interest of the user and characterize it as an information representation in a form that the recommendation system is able to understand and process. Generally, historical content items that were previously clicked, visited, or browsed by a user may indicate user interest of the user, so a user interest representation of the user may be generated based on the historical content items. Herein, a content item may refer to an individual item with specific content. For example, a piece of news, a piece of music, a movie, etc. may be referred to as a content item. Existing recommendation systems usually use a single embedding to characterize user interest. However, since user interest is complex, e.g., different users usually have different interests, a same user may have various interests, and different users may have different points of interest for a same content item, etc., thus it may be difficult for a single embedding to comprehensively and accurately characterize user interest. Embodiments of the present disclosure propose hierarchical representation learning of user interest. For example, a historical content item sequence of a user may be obtained. The historical content item sequence may comprise a plurality of historical content items that were previously clicked, visited, or browsed by the user. The historical content item may comprise e.g., news, music, movie, video, book, product information, etc. Subsequently, a topic and a text of each historical content item in the historical content item sequence may be identified, to obtain a topic sequence and a text sequence corresponding to the historical content item sequence. The text of the content item may comprise a title, an abstract, a body, etc., of the content item. Subsequently, a comprehensive topic representation may be generated based on the topic sequence, and a comprehensive text representation may be generated based on the text sequence. The generated comprehensive topic representation and comprehensive text representation may be used to generate a user interest representation of the user. The comprehensive topic representation and the comprehensive text representation may have different information abstraction levels. For example, relatively speaking, the comprehensive topic representation may characterize user interest at a coarser granularity, while the comprehensive text representation may characterize user interest at a finer granularity. Therefore, the process for generating the user interest representation described above may be considered as a process for hierarchical representation learning of user interest. In addition, the process described above takes into account multiple aspects of a historical content item, e.g., a topic, a title, an abstract, a body, etc., which may fully reflect information of the historical content item. Therefore, the method for hierarchical representation learning of user interest according to the embodiments of the present disclosure may effectively and comprehensively capture user interest, thereby generating an accurate and rich user interest representation. Further, the generated user interest representation may be used by a recommendation system to predict a click probability of the user clicking a target content item. The accurate and rich user interest representation may facilitate the recommendation system to predict a more accurate click probability, thereby achieving efficient and targeted content item recommendation.

In an aspect, the embodiments of the present disclosure propose to generate a comprehensive topic representation through constructing a topic graph corresponding to a topic sequence. In the topic graph, different topic categories in the topic sequence may be represented through different nodes, and the order in which a user clicks on different content items with different topic categories may be represented through edges among the nodes. When generating the comprehensive topic representation, representations of neighbor nodes of each node may be aggregated with relation information derived from the topic graph that represents relations among a plurality of nodes in the topic graph, and a representation of the node may be updated with the aggregated representations of the neighbor nodes, updated representations of the various nodes may be combined into the comprehensive topic representation. Herein, a neighbor node of a node may refer to a node that has an edge with the node. In this way, internal relations among the neighbor nodes may be propagated through structural connections in the topic graph, thereby information related to the topic sequence may be better captured.

In another aspect, the embodiments of the present disclosure propose to generate a comprehensive text representation through employing multiple ways. In an implementation, the comprehensive text representation may be generated through an attention mechanism based on a text sequence. Herein, a representation generated through an attention mechanism based on a text sequence may be referred to as a comprehensive text attention representation. In another implementation, the comprehensive text representation may be generated using a capsule network based on the text sequence. Herein, a representation generated using a capsule network based on a text sequence may be referred to as a comprehensive text capsule representation. These two implementations may be performed individually or in conjunction with each other. The comprehensive text attention representation and the comprehensive text capsule representation may have different information abstraction levels. For example, relatively speaking, the comprehensive text attention representation may characterize user interest at a coarser granularity, while the comprehensive text capsule representation may characterize user interest at a finer granularity.

In yet another aspect, the embodiments of the present disclosure propose a machine learning model that can employ the method described above for hierarchical representation learning of user interest to generate a user interest representation of a user, and predict a click probability of the user clicking a target content item. The target content item may be a content item from a set of candidate content items. The target content item may have the same content as the corresponding historical content item, including, e.g., news, music, movies, video, book, product information, etc. For each content item in a set of candidate content items, a click probability of the user clicking the content item may be predicted, thereby obtaining a set of click probabilities. Content item(s) to recommend to the user may be determined based on the predicted set of click probabilities. A machine learning model used to predict a click probability of a user clicking a target content item may be referred to as a click probability predicting model. The embodiments of the present disclosure propose to train a click probability predicting model through employing a negative sampling method. For example, a training dataset including a plurality of positive samples and a plurality of negative sample sets corresponding to the plurality of positive samples may be constructed. A content item that has been previously clicked by a user may be regarded as a positive sample, and a content item set that is presented in the same session as the positive sample but has not been clicked by the user may be regarded as a negative sample set corresponding to the positive sample. A posterior click probability corresponding to the positive sample may be generated based on the positive sample and the negative sample set corresponding to the positive sample. After obtaining a plurality of posterior click probabilities corresponding to a plurality of positive samples, a prediction loss may be generated, and the click probability predicting model may be optimized through minimizing the prediction loss.

It should be appreciated that although the foregoing discussion and the following discussion may involve taking the content item being news as an example to generate a user interest representation for a news recommendation system, the embodiments of the present disclosure are not limited to this, but may generate user interest representations for other types of recommendation systems in which content items are music, movies, videos, books, product information, etc. in a similar manner.

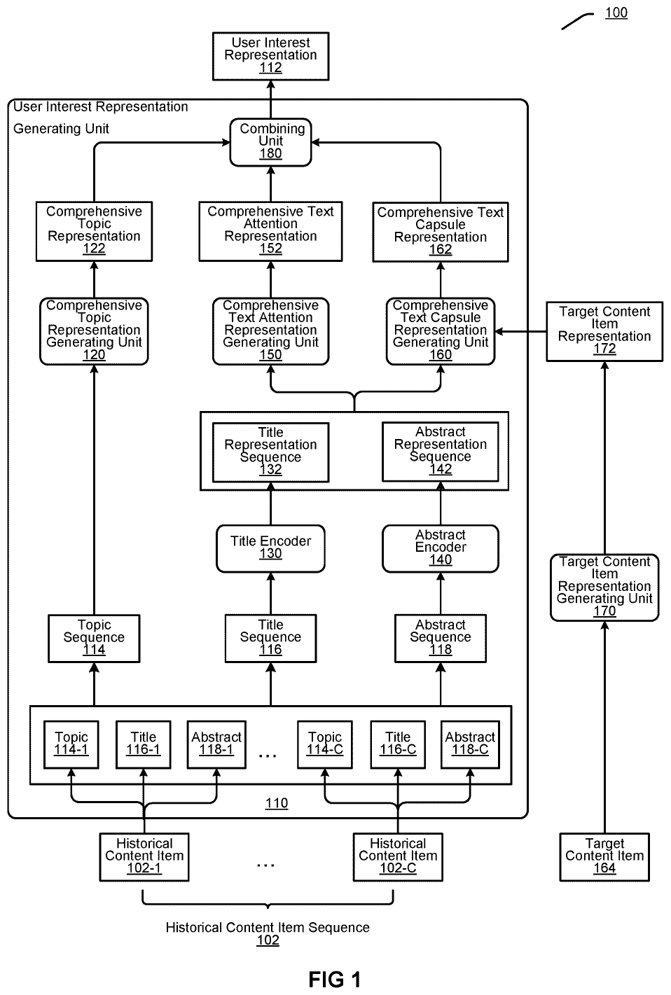

FIG. 1 illustrates an exemplary process 100 for hierarchical representation learning of user interest according to an embodiment of the present disclosure. In the process 100, a user interest representation 112 of a user may be generated through a user interest representation generating unit 110 based at least on a historical content item sequence 102 of the user.

Firstly, the historical content item sequence 102 of the user may be obtained. The historical content item sequence 102 may comprise a plurality of historical content items that the user has previously clicked, visited, or browsed, e.g., a historical content item 102-1 to a historical content item 102-C, where C is the number of historical content items. The historical content item may comprise e.g., news, music, movie, video, book, product information, etc. The historical content item sequence 102 of the user may indicate user interest of the user. Taking the historical content item being news as an example, news that has been previously clicked by the user may indicate which news the user is interested in.

Subsequently, a topic of each historical content item in the of historical content item sequence 102 may be identified. For example, for the historical content item 102-1, its topic 114-1 may be identified, and for the historical content item 102-C, its topic 114-C may be identified. Since a content item, even a brand-new content item, may be directly mapped to a specific topic, thus considering the topic of the historical content items when generating a user interest representation may facilitate to solve the data sparsity and cold-start problem. A text of each historical content item in the historical content item sequence 102 may also be identified. The text of a historical content item may comprise, e.g., a title, an abstract, a body, etc. In FIG. 1, for the sake of brevity, only the title and abstract are shown. For example, for the historical content item 102-1, its title 114-1 and abstract 118-1 may be identified, and for the historical content item 102-C, its title 114-C and abstract 118-C may be identified. However, it should be appreciated that other texts of various historical content items, e.g., body, etc., may also be identified. The topic, title, abstract, body, etc. of the historical content item may fully reflect information of the historical content item. The user interest representation generated based on these aspects of the historical content items may effectively and fully capture user interest, thereby generating an accurate and rich user interest representation.

A title and a text of a historical content item may be identified in a known way. The following takes the historical content item being a piece of news as an example to illustrate an exemplary process for identifying a topic and a text. The piece of news may be in the form of web page. A Hypertext Markup Language (HTML) of the web page may be parsed to obtain a title and a body of the piece of news. The obtained title and/or body may be input to a trained topic model. The topic model may output a topic corresponding to the piece of news. In addition, the obtained title and/or body may also be input to a trained abstract model. The abstract model may identify important paragraphs from the body and use them as an abstract of the piece of news. For other types of historical content items, their topics and texts may be identified through, e.g., a trained corresponding machine learning model.

After identifying the topic and the text of each historical content item in the historical content item sequence 102, the identified topics and texts may be combined, respectively, to obtain a topic sequence and a text sequence corresponding to the historical content item sequence 102. For example, the topic 114-1 to the topic 114-C may be combined into a topic sequence 114, the title 116-1 to the title 116-C may be combined into a title sequence 116, and the abstract 118-1 to the abstract 118-C may be combined into an abstract sequence 118. The title sequence 116 and/or the abstract sequence 118 may be collectively referred to as a text sequence.

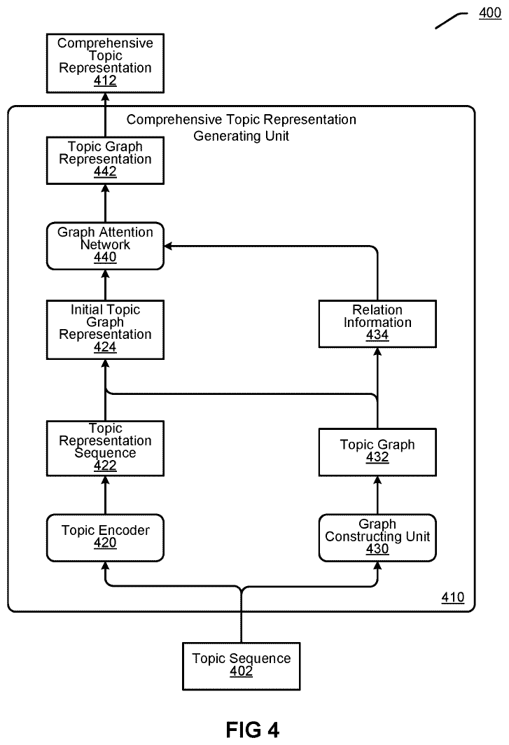

After obtaining the topic sequence 114, a comprehensive topic representation 122 may be generated through a comprehensive topic representation generating unit 120. An exemplary process for generating a comprehensive topic representation will be described later in conjunction with FIG. 4. The comprehensive topic representation 122 may be denoted as h₁.

In addition, a comprehensive text representation may be generated based on a text sequence. The comprehensive topic representation and the comprehensive text representation may have different information abstraction levels. For example, relatively speaking, the comprehensive topic representation may characterize user interest at a coarser granularity, while the comprehensive text representation may characterize user interest at a finer granularity. A comprehensive text attention representation 152 may be generated through an attention mechanism based on the text sequence. Alternatively or additionally, a comprehensive text capsule representation 162 may be generated using a capsule network based at least on the text sequence. The comprehensive text attention representation 152 and the comprehensive text attention representation 152 may be collectively referred to as a comprehensive text representation.

A title representation sequence 132 may be generated based on the title sequence 116 through a title encoder 130. For each title in the title sequence 116, the title encoder 130 may generate a title representation of the title, thereby obtaining a title representation sequence 132 corresponding to the title sequence 116. The title encoder 130 may comprise a word embedding layer and a Convolutional Neural Network (CNN) layer. The word embedding layer may convert a word sequence in the title into a low-dimensional word embedding sequence. A title identified from the i-th (1≤i≤C) historical content item may be denoted as lᵢ^{t}=[w₁, w₂, . . . , w_{M}_{ₜ}], where Mₜ is the number of words included in the title lᵢ^{t}. The word sequence may be converted into a word embedding sequence E^{t}=[e₁^{t}, e₂^{t}, . . . , e_{M}_{ₜ}^{t}] via a word embedding look-up table Wₑ ∈ [symbol] ^{V×D} through the word embedding layer, where V and D are a vocabulary size and a word embedding dimension, respectively. Then, for each word in the title, a context word representation of the word may be learned through capturing a local context of the word using the CNN layer. For each word, the context of the word is very important for learning the representation of the word. For example, in a news title “Xbox One Release This Week”, a context of a word “One”, e.g., “Xbox” and “Release”, may facilitate to understand it as belonging to the name of a game console. The context word representation of the i-th word in the title may be denoted as rᵢ^{t}, which may be calculated through, e.g., the following formula:

$${r}_{i}^{t} = R e L U ( {F}_{t} \times {e}_{( i - K ) : ( i + K )}^{t} + {b}_{t} ) \qquad ( 1 )$$

where ReLU is a non-linear activation function, e_{(i-K):(i+K)}^{t} is the concatenation of word embeddings of words from position (i−K) to position (i+K) in the word sequence, Ft E [symbol] ^{N}^{_{f}}^{×(2K+1)D} and bₜ ∈ [symbol] ^{N}^{_{f}} are the kernel and bias parameters of a CNN filter, respectively, N_{f} is the number of CNN filters, and (2K+1) is a window size of the CNN filter.

After the context word representation of each word in the title is obtained, the context representations of all the words in the title may be combined together to generate a title representation of the title. The title representation may be denoted as [r₁^{t}, r₂^{t}, . . . , r_{M}_{ₜ}^{t}]. The title representations of the various titles in the title sequence 116 may be combined into a title representation sequence 132.

Alternatively or additionally, an abstract representation sequence 142 may be generated based on an abstract sequence 118 through an abstract encoder 140. An abstract identified from the i-th historical content item may be denoted as lᵢ^{a}=[w₁, w₂, . . . , w_{M}_{ₐ}], where Mₐ is the number of words included in the abstract lᵢ^{a}. The abstract encoder 140 may have the same structure as the title encoder 130. For example, the abstract encoder 140 may comprise a word embedding layer and a CNN layer. For each abstract, the abstract encoder 140 may generate an abstract representation of the abstract. The abstract representation may be generated through a process similar to the process for generating the title representation. The abstract representation 682 is denoted as, e.g., [r₁^{a}, r₂^{a}, . . . , r_{M}_{ₐ}^{a}]. The abstract representations of the various abstracts in the abstract sequence 118 may be combined into an abstract representation sequence 142.

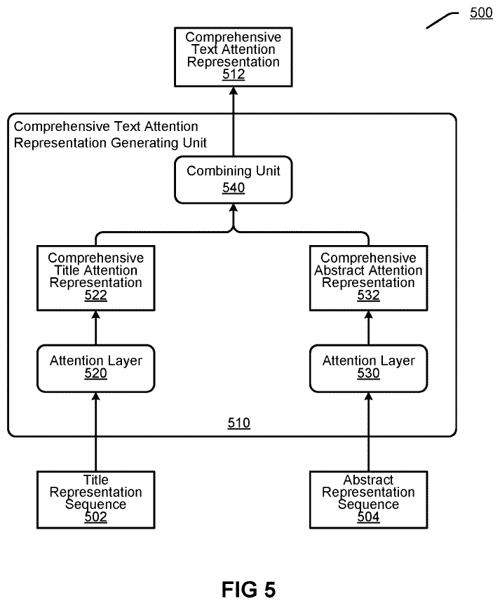

The title representation sequence 132 generated through the title encoder 130 and/or the abstract representation sequence 142 generated through the abstract encoder 140 may be provided to a comprehensive text attention representation generating unit 150. The comprehensive text attention representation generating unit 150 may generate a comprehensive text attention representation 152 through an attention mechanism. An exemplary process for generating a comprehensive text attention representation will be described later in conjunction with FIG.5. The comprehensive text attention representation 152 may be denoted as h₂.

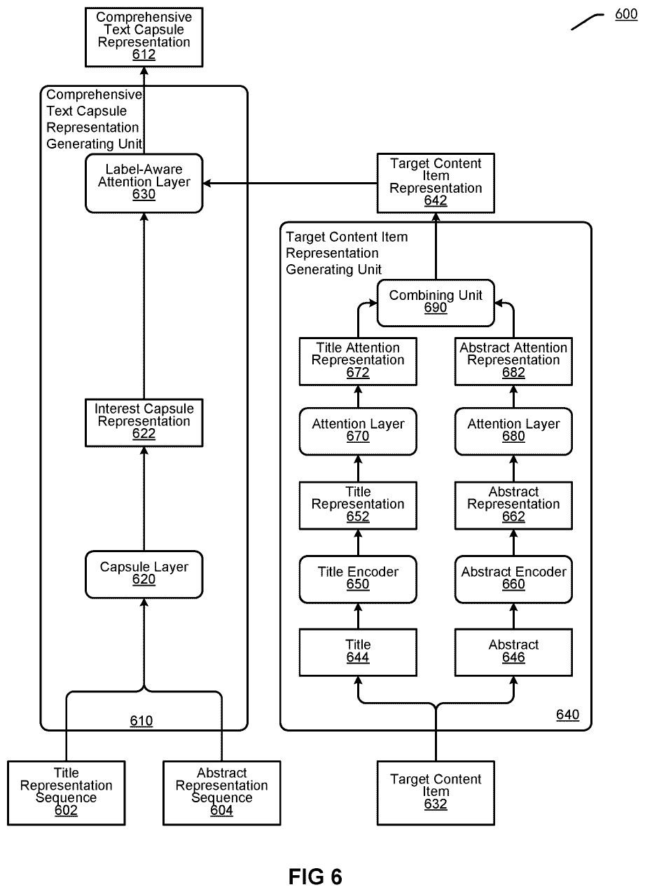

Alternatively or additionally, the title representation sequence 132 and/or the abstract representation sequence 142 may be provided to a comprehensive text capsule representation generating unit 160. The comprehensive text capsule representation generating unit 160 may generate a comprehensive text capsule representation 162 using a capsule network. Preferably, when generating the comprehensive text capsule representation 162, in order to more accurately measure the user's interest in the target content item 164, a target content item representation 172 of a target content item 164 may also be considered. The target content item representation 172 may be generated through a target content item representation generating unit 170. An exemplary process for generating a comprehensive text capsule representation will be described later in conjunction with FIG. 6. The comprehensive text capsule representation 162 may be denoted as h₃.

The comprehensive text attention representation 152 and the comprehensive text capsule representation 162 may have different information abstraction levels. For example, relatively speaking, the comprehensive text attention representation 152 may characterize user interest at a coarser granularity, while the comprehensive text capsule representation 162 may characterize user interest at a finer granularity. The comprehensive text attention representation 152 and/or the comprehensive text capsule representation 162 may be collectively referred to as a comprehensive text representation. The user interest representation 112 of the user may be generated based on the comprehensive topic representation 122 and the comprehensive text representation. The user interest representation 112 may be denoted as hᵤ. For example, the comprehensive topic representation 122, the comprehensive text attention representation 152, and the comprehensive text capsule representation 162 may be combined into the user interest representation 112 through a combining unit 180, as shown in the following formula:

$${h}_{u} = {h}_{1} + {h}_{2} + {h}_{3} \qquad ( 2 )$$

In the process 100, the user interest may be characterized using e.g., the comprehensive topic representation 122, the comprehensive text attention representation 152, the comprehensive text capsule representation 162, etc. These representations have different information abstraction levels and model user interest at different granularities. In addition, the process 100 takes into account multiple aspects of the historical content item, e.g., a topic, a title, an abstract, a body, etc., which may fully reflect information of the historical content item. Therefore, the method for hierarchical representation learning of user interest according to the embodiments of the present disclosure may effectively and comprehensively capture user interest, thereby generating an accurate and rich user interest representation. Further, the generated user interest representation may be used by a recommendation system to predict a click probability of the user clicking a target content item. The accurate and rich user interest representation may facilitate the recommendation system to predict a more accurate click probability, thereby achieving efficient and targeted content item recommendation.

It should be appreciated that although FIG. 1 shows that the text identified from each historical content item includes both the title and the abstract, however, it is also possible to identify only one of the title and the abstract from each historical content item. Accordingly, when generating a comprehensive text representation, it may be based only on one of the title sequence and the abstract sequence. In addition, in addition to the title and/or abstract, other texts of each historical content item, e.g., body, may also be identified. Accordingly, when generating a comprehensive text representation, it may also be based on other identified text sequences. In addition, it should be appreciated that although FIG. 1 shows that the user interest representation 112 is generated based on three of the comprehensive topic representation 122, the comprehensive text attention representation 152, and the comprehensive text capsule representation 162, however, when generating the user interest representation 112, it is also possible to consider only one or two of the comprehensive topic representation 122, the comprehensive text attention representation 152, and the comprehensive text capsule representation 162.

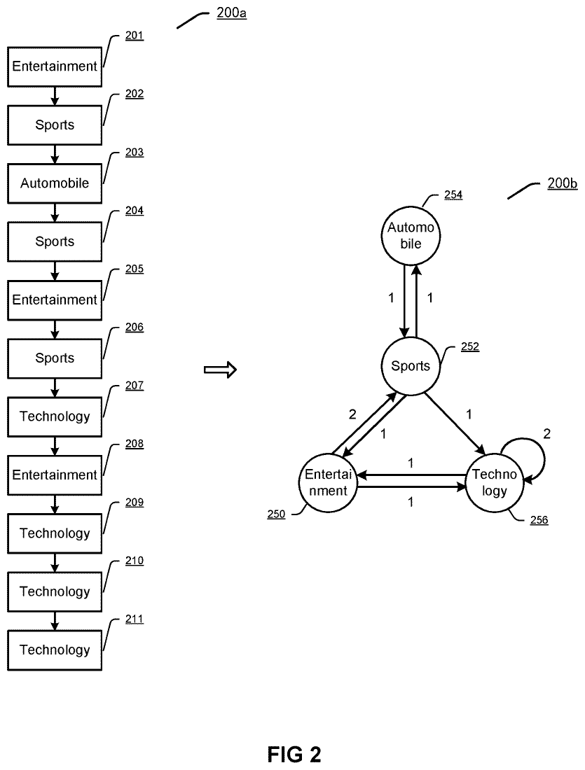

According to the embodiments of the present disclosure, a comprehensive topic representation may be generated through constructing a topic graph corresponding to a topic sequence. FIG. 2 illustrates an exemplary topic sequence 200a and a corresponding topic graph 200b according to an embodiment of the present disclosure. The topic sequence 200a may be, e.g., related to news, which indicates a series of topics corresponding to a series of news that are successively clicked by a user. A topic 201 to a topic 211 may be “Entertainment”, “Sports”, “Automobile”, “Sports”, “Entertainment”, “Sports”, “Technology”, “Entertainment”, “Technology”, “Technology” and “Technology” in sequence. A topic graph corresponding to the topic sequence 200a may be constructed, e.g., the topic graph 200b.

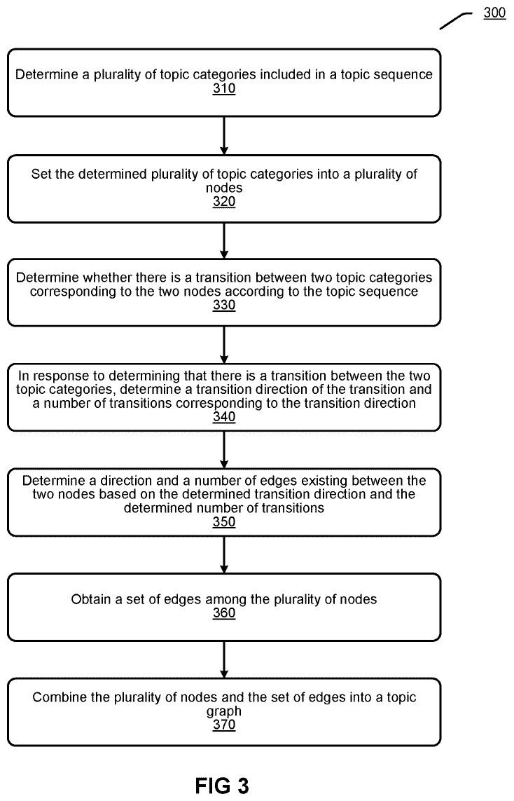

FIG. 3 illustrates an exemplary process 300 for constructing a topic graph according to an embodiment of the present disclosure. Through the process 300, a topic graph corresponding to a topic sequence may be constructed.

At 310, a plurality of topic categories included in a topic sequence may be determined. For example, for the topic sequence 200a in FIG. 2, it may comprise 4 topic categories, i.e., “Entertainment”, “Sports”, “Automobile” and “Technology”.

At 320, the determined plurality of topic categories may be set into a plurality of nodes. For example, as shown in the topic graph 200b in FIG. 2, the 4 topic categories “Entertainment”, “Sports”, “Automobile” and “Technology” may be set as a node 250, a node 252, a node 254, and a node 256, respectively.

Subsequently, a set of edges among the plurality of nodes may be determined. For example, for every two nodes in the plurality of nodes, at 330, it may be determined whether there is a transition between two topic categories corresponding to the two nodes according to the topic sequence. The topic sequence corresponds to the click order of the user. It may be determined whether there is a transition between the two topic categories based on whether the user has clicked two content items corresponding to the two topic categories successively. For example, for the node 250 and the node 252 shown in the topic graph 200b, it may be determined, according to the topic sequence 200a, that there is a transition between the two topic categories corresponding to the two nodes, i.e., “Technology” and “Sports”; and for the node 254 and the node 250 shown in the topic graph 200b, it may be determined, according to the topic sequence 200a, that there is no transition between the two topic categories corresponding to the two nodes, i.e., “Automobile” and “Entertainment”. In addition, the user may successively click two or more content items with the same topic category. For example, in the topic sequence 200a, the topic 209 to the topic 211 are all “Technology”, which means that the user has successively clicked three content items whose topic categories are all “Technology”.

At 340, in response to determining that there is a transition between the two topic categories, a transition direction of the transition and a number of transitions corresponding to the transition direction may be determined. The transition direction and the number of transitions may be determined according to the topic sequence. For example, for the two topic categories “Entertainment” and “Sports”, it may be seen from the topic sequence 200a that the transition direction includes from the topic category “Entertainment” to the topic category “Sports”, e.g., from the topic 201 to the topic 202, and from the topic 205 to the topic 206. Accordingly, the number of transitions corresponding to the transition direction may be “2”. In addition, the transition direction also includes from the topic category “Sports” to the topic category “Entertainment”, e.g., from the topic 204 to the topic 205. Accordingly, the number of transitions corresponding to the transition direction may be “1”.

At 350, a direction and a number of edges existing between the two nodes may be determined based on the determined transition direction and the determined number of transitions. The direction of the edge existing between the two nodes may be consistent with the determined transition direction, which may be indicated by an arrow in the topic graph 200b. The number of edges existing between the two nodes may be consistent with the determined number of transitions. The number of each edge may be labeled near the edge, as shown by a number near each edge in the topic graph 200b. There are edges between the node 256 and itself, and the number of edges is “2”, since the user has successively clicked three content items whose topic categories are all “Technology”.

The step 330 to the step 350 may be performed for every two nodes in the plurality of nodes. At 360, a set of edges among the plurality of nodes may be obtained.

At 370, the plurality of nodes and the obtained set of edges may be combined into a topic graph. It should be appreciated that the process for constructing the topic graph described above in conjunction with FIG. 2 to FIG. 3 is merely exemplary. Depending on actual application requirements, the steps in the process for constructing the topic graph may be replaced or modified in any manner, and the process may comprise more or fewer steps. In addition, the specific order or hierarchy of the steps in the process 300 is merely exemplary, and the process for constructing the topic graph may be performed in an order different from the described order.

FIG. 4 illustrates an exemplary process 400 for generating a comprehensive topic representation according to an embodiment of the present disclosure. In the process 400, a comprehensive topic representation 412 may be generated based on a topic sequence 402 through a comprehensive topic representation generating unit 410. The topic sequence 402, the comprehensive topic representation generating unit 410, and the comprehensive topic representation 412 may correspond to the topic sequence 114, the comprehensive topic representation generating unit 120 and the comprehensive topic representation 122 in FIG. 1, respectively. In the process 400, a topic representation sequence 422 corresponding to the topic sequence 402 may be generated; a topic graph 432 corresponding to the topic sequence 402 may be constructed; and the comprehensive topic representation 412 may be generated based on the generated topic representation sequence 422 and the constructed topic graph 432.

The topic sequence 402 may comprise a plurality of topics. The topic sequence 402 may be provided to a topic encoder 420 to generate a topic representation sequence 422. For each topic in the topic sequence 402, the topic encoder 420 may generate a topic representation of the topic, thereby obtaining a topic representation sequence 422 corresponding to the topic sequence 402. The topic encoder 420 may have a structure similar to the title encoder 130 or the abstract encoder 140. The difference is that the topic encoder 420 includes a Multilayer Perceptron (MLP) layer instead of a CNN layer. Specifically, since the number of words included in a topic is usually smaller than the number of words included in a title or an abstract, the topic encoder 420 may employ the MLP layer to generate a topic representation. That is, the topic encoder 420 may comprise a word embedding layer and a MLP layer. A topic identified from the i-th historical content item may be denoted as lᵢ^{p}=[w₁, w₂, . . . , w_{M}_{ₚ}], where Mp is the number of words included in the topic lᵢ^{p}. The word sequence may be converted into a word embedding sequence E^{p}=[e₁^{p}, e₂^{p}, . . . , e_{M}_{ₚ}^{p}] via the word embedding look-up table Wₑ ∈ [symbol] ^{V×D} through the word embedding layer. Then, a topic representation of the topic lᵢ^{p} may be obtained through the MLP layer, as shown through the following formula:

$${r}_{i}^{p} = R e L U ( {W}_{m} \times {E}^{p} + {b}_{m} ) \qquad ( 3 )$$

where Wₘ ∈ [symbol] ^{M×D} and bₘ ∈ [symbol] ^{M} are the matrix and bias parameters of the MLP layer, respectively.

After topic representations of the various topics are obtained, the topic representations of the various topics in the topic sequence 402 may be combined into a topic representation sequence 422.

A topic graph 432 corresponding to the topic sequence 402 may be constructed through a graph constructing unit 430. The topic graph 432 may be composed of a plurality of nodes corresponding to a plurality of topic categories included in the topic sequence 402 and a set of edges among these nodes. The topic graph 432 may be constructed through, e.g., the process for constructing the topic graph described above in conjunction with FIG. 2 to FIG. 3.

After the topic graph 432 is constructed, relation information 434 may be derived from the topic graph 432. The relation information 434 may be used to represent relations among the plurality of nodes in the topic graph 432. Graph edge information between every two nodes in the topic graph may be acquired, including graph edge information between the node and itself. Subsequently, the number of edges associated with each node in the topic graph may be calculated, and the relation information may be derived based on the graph edge information and the number of edges.

Firstly, graph edge information between every two nodes may be acquired from the topic graph, including graph edge information between a node and itself. The graph edge information may be [symbol] related to a direction of an edge. Graph edge information of a node [symbol] ₘ to a node [symbol] ₙ may be used to indicate whether there is an edge between the node [symbol] ₘ and the node [symbol] ₙ, and the number of edges if so. The graph edge information of the node [symbol] ₘ to the node [symbol] ₙ may be denoted as, e.g., Aₘₙ, where when there is no edge from the node [symbol] ₘ to the node [symbol] ₙ, Aₘₙ=0, and when there is an edge from the node [symbol] ₘ to the node [symbol] ₙ, Aₘₙ=G, where G is the number of edges. Referring back to FIG. 2, the graph edge information of the node 254 to the node 252 may be “1”, and the graph edge information of the node 256 to itself may be “2”.

The above steps may be performed on every two nodes in the topic graph, to obtain a set of graph edge information {Aₘₙ}. Subsequently, this set of graph edge information may be combined into a matrix A∈ [symbol] ^{NxN}, where N is the number of nodes. The matrix A may be referred to as a graph adjacency matrix.

Next, the number of edges associated with each node in the topic graph may be calculated. For example, the number of edges associated with each node may be calculated through summing the graph edge information associated with the node. For example, the number of edges associated with the node [symbol] ₘ may be represented as Dₘₘ=ΣₙAₘₙ.

The above steps may be performed on each node in the topic graph, to obtain a plurality of the number of edges {Dₘₘ}. Then, the plurality of the number of edges may be combined into a matrix D∈ [symbol] ^{N×N} The matrix D may be referred to as a graph degree matrix. The graph degree matrix D may be e.g., a diagonal matrix. In this diagonal matrix, all elements are 0 except the main diagonal.

At least the graph adjacency matrix A and the graph degree matrix D may be considered as the relation information 434 derived from the topic graph 432. The relation information 434 may be further used to generate a comprehensive topic representation 412. In an implementation, the comprehensive topic representation 412 may be generated based on a topic representation sequence 422 and relation information 434.

The topic representation sequence 422 may comprise topic representations of the various topics in the topic sequence 402. The topic graph 432 may comprise a plurality of nodes corresponding to a plurality of topic categories in the topic sequence 402. An initial topic graph representation 424 may be generated based on the topic representation sequence 422 and the topic graph 432.

The initial topic graph representation 424 may comprise initial node representations of the various nodes in the topic graph 432. An initial node representation of each node may be consistent with a topic representation of a topic category corresponding to the node. The initial topic graph representation 424 may be denoted as L⁽⁰⁾={rᵢⁿ}_{i=1 . . . N}, where rᵢⁿ is the node representation of the i-th node.

Subsequently, the initial topic graph representation 424 may be updated to a topic graph representation 442 based on the relation information 434 through a graph attention network 440. The graph attention network 440 may have a two-layer structure. At each layer, the graph attention network 440 may aggregate representations of neighbor nodes of the various nodes, and update the representation of the node with the aggregated representations of the neighbor nodes. The process for updating the initial topic graph representation 424 to the topic graph representation 442 based on the relation information 434 may be represented through the following formula:

$${L}^{( l )} = ReLU ( {\tilde{D}}^{- \frac{1}{2}} \tilde{A} {\tilde{D}}^{- \frac{1}{2}} {L}^{( l - 1 )} {W}^{( l - 1 )} ) \qquad ( 1 )$$

where L^{(l)} represents the output of the l-th layer (l=1,2) of the graph attention network 440, ReLU is a non-linear activation function, and W^{(l-1)} is the learnable weight matrix of the l−1 layer. In formula (4), the symbol “˜” indicates a renormalization operation, e.g., adding a self-connection to each node in the graph when constructing a graph adjacency matrix A or a graph degree matrix D. This operation makes it possible to update the representation of the l-th layer of each node with the representation of the l−1-th layer of the node. In the case where the node itself has self-connection, such as the node 256 in FIG. 2, the self-connection addition operation may not be performed on the node. L⁽²⁾ represents the updated representation obtained after two rounds of convolution, which may be used as the topic graph representation 442.

After the topic graph representation 442 L⁽²⁾ is obtained, a comprehensive topic representation 412 h₁ may be generated based on the topic graph representation L⁽²⁾, as shown through the following formula:

$${h}_{1} = {\sum }_{i = 1}^{N} {L}_{i}^{( 2 )} \qquad ( 2 )$$

It should be appreciated that the process for generating the comprehensive topic representation described above in conjunction with FIG. 4 is merely exemplary. Depending on actual application requirements, the steps in the process for generating the comprehensive topic representation may be replaced or modified in any manner, and the process may comprise more or fewer steps. In addition, the specific order or hierarchy of the steps in the process 400 is merely exemplary, and the process for generating the comprehensive topic representation may be performed in an order different from the described order.

FIG. 5 illustrates an exemplary process 500 for generating a comprehensive text attention representation according to an embodiment of the present disclosure. In the process 500, a comprehensive text attention representation 512 may be generated based on a text representation sequence, e.g., a title representation sequence 502 and an abstract representation sequence 504, through a comprehensive text attention representation generating unit 510. The title representation sequence 502, the abstract representation sequence 504, the comprehensive text attention representation generating unit 510, and the comprehensive text attention representation 512 may correspond to the title representation sequence 132, the abstract representation sequence 142, the comprehensive text attention representation generating unit 150 and the comprehensive text attention representation 152 in FIG. 1, respectively. In the process 500, the comprehensive text attention representation 512 may be generated through an attention mechanism.

The title representation sequence 502 may comprise context word representations of various words in a title sequence. A comprehensive title attention representation 522 may be generated based on the title representation sequence 502 through an attention layer 520. For each word in the title sequence, an additive attention weight of the word may be calculated based on interaction between the context word representations. An additive attention weight of the i-th word may be denoted as αᵢ^{t}, which may be calculated through, e.g., the following formula:

$${α}_{i}^{t} = \frac{exp ( {r}_{i}^{t} )}{{\sum }_{j = 1}^{{M}_{T}} exp ( {r}_{j}^{t} )} \qquad ( 6 )$$

where rᵢ^{t} and rⱼ^{t} are a context word representation of the i-th word and the j-th word obtained through the above formula (1), respectively, and M_{T} is the number of words included in the title sequence. Subsequently, a comprehensive title attention representation 522 h₂^{t} may be generated through, e.g., the following formula:

$${h}_{2}^{t} = {\sum }_{i = 1}^{{M}_{T}} {α}_{i}^{t} {r}_{i}^{t} \qquad ( 7 )$$

The abstract representation sequence 504 may comprise context word representations of various words in an abstract sequence. A comprehensive abstract attention representation 532 may be generated in a manner similar to the manner in which the comprehensive title attention representation 522 is generated. For example, a comprehensive abstract attention representation 532 may be generated based on the abstract representation sequence 504 through an attention layer 530. For each word in the abstract sequence, an additive attention weight of the word may be calculated based on interactions between the context word representations. An additive attention weight of the i-th word may be denoted as aa, which may be calculated through, e.g., the following formula:

$${α}_{i}^{a} = \frac{exp ( {r}_{i}^{a} )}{{\sum }_{j = 1}^{{M}_{A}} exp ( {r}_{j}^{a} )} \qquad ( 8 )$$

where rᵢ^{a} and rⱼ^{a} are a context word representation of the i-th word and the j-th word obtained through the above formula (1), respectively, and M_{A} is the number of words included in the abstract sequence. Subsequently, the comprehensive abstract attention representation 532 h₂^{a} may be generated through, e.g., the following formula:

$${h}_{2}^{a} = {\sum }_{i = 1}^{{M}_{A}} {α}_{i}^{a} {r}_{i}^{a} \qquad ( 9 )$$

Then, the comprehensive text attention representation 512 h₂ may be generated based on the comprehensive title attention representation 522 h₂^{t} and the comprehensive abstract attention representation 532 h₂^{a} through a combining unit 540. The comprehensive text attention representation h₂ may be generated through, e.g., summing the comprehensive title attention representation h₂^{t} and the comprehensive abstract attention representation h₂^{a}, as shown in the following formula:

$${h}_{2} = {h}_{2}^{t} + {h}_{2}^{a} \qquad ( 10 )$$

It should be appreciated that the process for generating the comprehensive text attention representation described above in conjunction with FIG. 5 is merely exemplary. Depending on actual application requirements, the steps in the process for generating the comprehensive text attention representation may be replaced or modified in any manner, and the process may comprise more or fewer steps. For example, although in the process 500, the comprehensive text attention representation 512 is generated based on both the title representation sequence 502 and the abstract representation sequence 504, in some embodiments, the comprehensive text attention representation 512 may be generated based only on one of the title representation sequence 502 and the abstract representation sequence 504. In addition, in addition to the title representation sequence 502 and the abstract representation sequence 504, the comprehensive text attention representation 512 may also be generated based on other text representation sequences corresponding to other texts such as the body. In addition, the specific order or hierarchy of the steps in the process 500 is merely exemplary, and the process for generating the comprehensive text attention representation may be performed in an order different from the described order. FIG. 6 illustrates an exemplary process 600 for generating a comprehensive text capsule representation according to an embodiment of the present disclosure. In the process 600, a comprehensive text capsule representation may be generated using a capsule network based at least on a text representation sequence. The text representation sequence may comprise a title representation sequence 602 and an abstract representation sequence 604. The title representation sequence 602 and the abstract representation sequence 604 may correspond to the title representation sequence 132 and the abstract representation sequence 142 in FIG. 1, respectively. A comprehensive text capsule representation 612 may be generated at least through a comprehensive text capsule representation generating unit 610. The comprehensive text capsule representation generating unit 610 and the comprehensive text capsule representation 612 may correspond to the comprehensive text capsule representation generating unit 160 and the comprehensive text capsule representation 162 in FIG. 1, respectively.

The comprehensive text capsule representation generating unit 610 may comprise a capsule layer 620 with dynamic routing and a label-aware attention layer 630. Through the capsule layer 620 and the label-aware attention layer 630, a fine-grained user interest representation may be learned. The title representation sequence 602 and the abstract representation sequence 604 may be provided to the capsule layer 620. In the capsule layer 620, two levels of capsules may be used, i.e., low-level capsules and high-level capsules. The goal of the dynamic routing is to calculate representations of the high-level capsules based on representations of the low-level capsules in an iterative manner. Such an operation may be regarded as a further encapsulation of lower features, thereby obtaining higher abstracted features. A representation of the i-th low-level capsule may be denoted as cᵢ^{l}, and a representation of the j-th high-level capsule may be denoted as cⱼ^{h}. The process for dynamic routing may be represented, e.g., through the following formula:

$${b}_{i , j} = {( {c}_{j}^{h} )}^{T} {S}_{i , j} {c}_{i}^{l} \qquad ( 11 )$$

$${w}_{i , j} = \frac{exp ( {b}_{i , j} )}{{\sum }_{k = 1}^{P} exp ( {b}_{i , k} )} \qquad ( 12 )$$

where S_{i,j} is a matching matrix to be learned between the representation cᵢ^{l} of the low-level capsule and the representation cⱼ^{h} of the high-level capsule, b_{i,j} is a routing parameter between the representation cᵢ^{l} of the low-level capsule and the representation cⱼ^{h} of the high-level capsule, P is the number of the high-level capsules, and w_{i,j} is the calculated weight between the representation cᵢ^{l} of the low-level capsule and the representation cⱼ^{h} of the high-level capsule.

After the dynamic routing is performed, a updated value of the representation of the high-level capsule may be calculated. Firstly, a candidate vector may be calculated, and then a squash function may be applied to represent the probability of the higher-level feature with the mold length. The above process may be represented through the following formula:

$${r}_{j}^{h} = {\sum }_{i = 1}^{Q} {w}_{i , j} , {S}_{i , j} {c}_{i}^{l} \qquad ( 13 )$$

$${c}_{j}^{h} = squash ( {r}_{j}^{h} ) = \frac{{‖ {r}_{j}^{h} ‖}^{2}}{1 + {‖ {r}_{j}^{h} ‖}^{2}} \frac{{r}_{j}^{h}}{{‖ {r}_{j}^{h} ‖}^{2}} \qquad ( 14 )$$

where Q is the number of the low-level capsules, ∥·∥ represents the model length calculation, and rⱼ^{h} represents a candidate vector for the representation cⱼ^{h} of the high-level capsule.

Through the operations described above, representations cⱼ^{h} of P high-level capsules may be obtained as an interest capsule representation 622 output by the capsule layer 620. The dynamic routing process described above may be regarded as a soft-clustering process, which may aggregate historical interactions of a user into several clusters, thus it can ensure that a representation learned by each interest capsule is as different as possible, thereby, different interest capsules may characterize different interests of a user from different aspects.

In order to more accurately measure the user's interest in a target content item 632, preferably, when generating the comprehensive text capsule representation 612, a target content item representation 642 of the target content item 632 may be considered. The target content item 632 may be a content item from a set of candidate content items. The target content item 632 may have the same content as the corresponding historical content item, including, e.g., news, music, movies, video, book, product information, etc. A target content item representation 642 of the target content item 632 may be generated through a target content item representation generating unit 640. The target content item 632, the target content item representation generating unit 640, and the target content item representation 642 may correspond to the target content item 164, the target content item representation generating unit 170, and the target content item representation 172 in FIG. 1, respectively.

Firstly, a text of the target content item 632, e.g., a title 644, an abstract 646, etc., may be extracted. Subsequently, a text representation of the extracted text may be generated. For example, a title representation 652 of the title 644 may be generated through a title encoder 650. Alternatively or additionally, an abstract representation 662 of the abstract 646 may be generated through an abstract encoder 660. The title encoder 650 and the abstract encoder 660 may have the same structure as the title encoder 130 in FIG. 1. Then, the target content item representation 642 may be generated based on the text representation through the attention mechanism. For example, a title attention representation 672 may be generated based on the title representation 652 through an attention layer 670. The title attention representation 672 may be denoted as hₗ^{t}. Alternatively or additionally, an abstract attention representation 682 may be generated based on the abstract representation 662 through an attention layer 680. The abstract attention representation 682 may be denoted as hₗ^{a}. The processing at the attention layer 670 and the attention layer 680 may be similar to the processing at the attention layer 520 and the attention layer 530 in FIG.5.

Accordingly, the title attention representation 672 may be generated through a process similar to the process for generating the comprehensive title attention representation 522, and the abstract attention representation 682 may be generated through a process similar to the process for generating the comprehensive abstract attention representation 532. The title attention representation hₗ^{t} and abstract attention representation hₗ^{a} may be combined through a combining unit 690, to generate a target content item representation 642 hₗ, as shown in the following formula:

$${h}_{l} = {h}_{l}^{r} + {h}_{l}^{a} \qquad ( 15 )$$

After the interest capsule representation 622 and the target content item representation 642 are generated, the comprehensive text capsule representation 612 may be generated through a label-aware attention layer 630. At the label-aware attention layer 630, a relevance of the interest capsules to the target content item 632 may be obtained through calculating the likelihood between the interest capsule representation 622 and the target content item representation 642. In an implementation, the attention query may be the target content item representation 642, and both the key and the value may be the interest capsule representation 622. The attention weight of the i-th interest capsule may be denoted as βᵢ, which may be calculated through, e.g., the following formula:

$${β}_{i} = \frac{exp ( {c}_{i}^{h} {h}_{l} )}{{\sum }_{j = 1}^{P} exp ( {c}_{j}^{h} {h}_{l} )} \qquad ( 16 )$$

Subsequently, the comprehensive text capsule representation 612 h₃ may be generated through, e.g., the following formula:

$${h}_{3} = {\sum }_{i = 1}^{P} {β}_{i} {c}_{i}^{h} \qquad ( 17 )$$

It should be appreciated that the process for generating the comprehensive text capsule representation described above in conjunction with FIG. 6 is merely exemplary. Depending on actual application requirements, the steps in the process for generating the comprehensive text capsule representation may be replaced or modified in any manner, and the process may comprise more or fewer steps. For example, although in the process 600, the interest capsule representation 622 is generated based on both the title representation sequence 602 and the abstract representation sequence 604, in some embodiments, the interest capsule representation 622 may be generated based only on one of the title representation sequence 602 and the abstract representation sequence 604. In addition, in addition to the title representation sequence 602 and the abstract representation sequence 604, the interest capsule representation 622 may also be generated based on other text representation sequences corresponding to other texts such as the body. In addition, when generating the target content item representation 642, in addition to the title 644 and the abstract 646, the target content item representation 642 may also be generated based on other texts such as the body. Furthermore, although in the process 600, the comprehensive text capsule representation 612 is generated based on both the interest capsule representation 622 and the target content item representation 642, in some embodiments, the comprehensive text capsule representation 612 may be generated based only on the interest capsule representation 622.

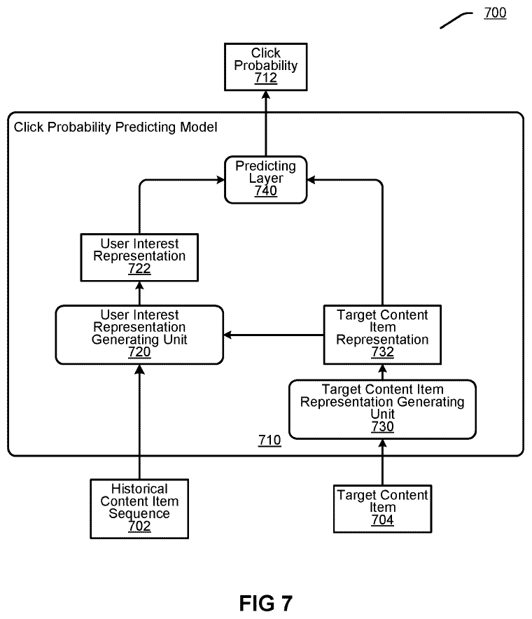

The exemplary process for generating the user interest representation of the user according to the embodiment of the present disclosure is described above in conjunction with FIG. 1 to FIG. 6. After the user interest representation is generated, the user interest representation may be further used to predict a click probability of the user clicking a target content item. A target content item may be a content item from a set of candidate content items. The target content item may have the same content as the corresponding historical content item, including, e.g., news, music, movies, video, book, product information, etc. For each content item in the set of candidate content items, a click probability of the user clicking the content item may be predicted, thereby obtaining a set of click probabilities. Content item(s) to recommend to the user may be determined based on the predicted set of click probabilities. FIG. 7 illustrates an exemplary process 700 for predicting a click probability according to an embodiment of the present disclosure. In the process 700, a historical content item sequence 702 of a user and a target content item 704 may be provided to a click probability predicting model 710. The click probability predicting model 710 may predict and output a click probability of the user clicking the target content item 704 based on the historical content item sequence 702 and the target content item 704.

The historical content item sequence 702 may correspond to the historical content item sequence 102 in FIG. 1, and may comprise a set of historical content items that have been previously clicked by the user. The historical content item sequence 702 may be provided to a user interest representation generating unit 720 in the click probability predicting model 710. The user interest representation generating unit 720 may correspond to the user interest representation generating unit 110 in FIG. 1. The user interest representation generating module 720 may generate a user interest representation 722 hᵤ of the user.

The target content item 704 may correspond to the target content item 164 in FIG. 1. The target content item 704 may be provided to a target content item representation generating unit 730 in the click probability predicting model 710. The target content item representation generating unit 730 may correspond to the target content item representation generating unit 170 in FIG. 1 and the target content item representation generating unit 640 in FIG. 6. The target content item representation generating unit 730 may generate a target content item representation 732 hₗ of the target content item 704. Preferably, the user interest representation generating unit 720 may consider the target content item representation 732 hₗ when generating the user interest representation 722, so as to more accurately measure the user's interest in the target content item 704.

The user interest representation 722 and the target content item representation 732 may be provided to a predicting layer 740 in the click probability predicting model 710. The predicting layer 740 may predict a click probability of the user clicking the target content item 704 based on the user interest representation 722 and the target content item representation 732. The click probability may be denoted as ŷ. In an implementation, the click probability ŷ may be predicted through applying the dot product method to calculate the distance between the user interest representation 722 and the target content item representation 732, as shown through the following formula:

$$\hat{y} = {h}_{l} \cdot {h}_{u} \qquad ( 18 )$$

It should be appreciated that the process for predicting the click probability described above in conjunction with 7 is merely exemplary. Depending on actual application requirements, the steps in the process for predicting the click probability may be replaced or modified in any manner, and the process may comprise more or fewer steps. In addition, the specific order or hierarchy of the steps in the process 700 is merely exemplary, and the process for predicting the click probability may be performed in an order different from the described order.

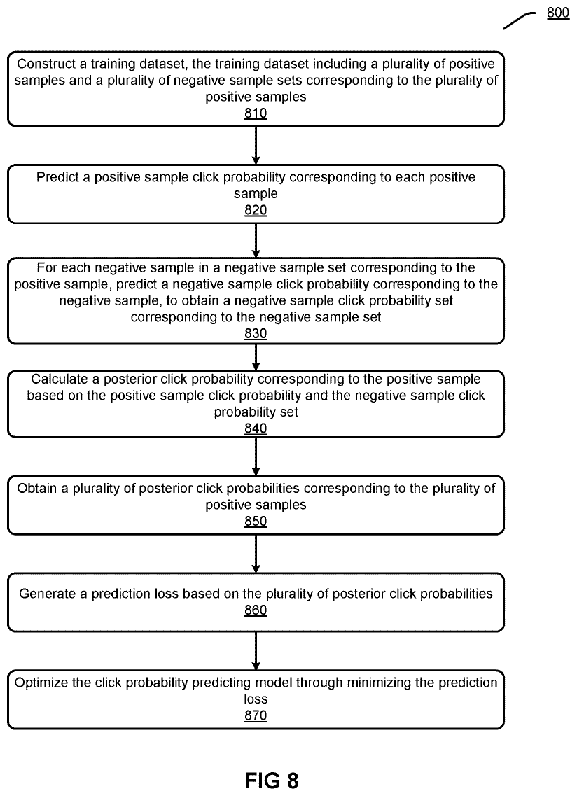

The embodiments of the present disclosure propose to train a click probability predicting model, e.g., the click probability predicting model 710 in FIG. 7, through employing a negative sampling method. FIG. 8 illustrates an exemplary process 800 for training a click probability predicting model according to an embodiment of the present disclosure. The click probability predicting model trained through the process 800, when actually deployed, may predicting a click probability of a user clicking a target content item.

At 810, a training dataset for training a click probability predicting model may be constructed. In an implementation, a list-wise strategy may be employed to construct the training dataset. Taking the click probability predicting model as a model for predicting a click probability of a user clicking target news as an example, a training dataset used to train the click probability predicting model may be constructed from news that has been previously clicked by the user and news that has not been previously clicked by the user. For example, a plurality of news that have been previously clicked by the user may be regarded as a plurality of positive samples. For each positive sample, a news set that is presented in the same session as the positive sample but has not been clicked by the user may be regarded as a negative sample set corresponding to the positive sample. Accordingly, the constructed training dataset may comprise a plurality of positive samples and a plurality of negative sample sets corresponding to the plurality of positive samples.

Subsequently, a posterior click probabilities corresponding to the plurality of positive samples may be generated. For example, at 820, a positive sample click probability corresponding to each positive sample may be predicted. The positive sample click probability corresponding to the i-th positive sample may be denoted as ŷᵢ⁺.

At 830, for each negative sample in a negative sample set corresponding to the positive sample, a negative sample click probability corresponding to the negative sample may be predicted, to obtain a negative sample click probability set corresponding to the negative sample set. A negative sample click probability set corresponding to a negative sample set of the i-th positive sample may be denoted as [ŷ_{i̅,̅1̅}, ŷ_{i̅,̅2̅}, . . . , ŷ_{i̅,̅K̅}], where K is the number of negative samples included in the negative sample click probability set. In this way, the click probability predicting problem may be formulated as a pseudo K+1-way classification task.

At 840, a posterior click probability corresponding to the positive sample may be calculated based on the positive sample click probability and the negative sample click probability set. A posterior click probability corresponding to the i-th positive sample may be denoted as pᵢ. In an implementation, the posterior click probability corresponding to the positive sample may be calculated through normalizing the positive sample click probability ŷᵢ⁺ and the negative sample click probability set [ŷ_{i̅,̅1̅}, ŷ_{i̅,̅2̅}, . . . , ŷ_{i̅,̅K̅}] using a softmax function, as shown in the following formula:

$${p}_{i} = \frac{exp ( {\hat{y}}_{i}^{+} )}{exp ( {\hat{y}}_{i}^{+} ) + {\sum }_{j = 1}^{K} {\hat{y}}_{i , j}^{-}} \qquad ( 19 )$$

The operations from the step 820 to the step 840 described above may be performed for each of the plurality of positive samples in the training dataset, so that at 850, a plurality of posterior click probabilities corresponding to the plurality of positive samples may be obtained.

At 860, a prediction loss may be generated based on the plurality of posterior click probabilities. In an implementation, the prediction loss may be generated through calculating a negative log-likelihood of the plurality of posterior click probabilities, as shown in the following formula:

$$ℒ = - {\sum }_{i ϵ S} log ( {p}_{i} ) \qquad ( 20 )$$

where S is a positive sample set composed of the plurality of positive samples.

At 870, the click probability predicting model may be optimized through minimizing the prediction loss.

It should be appreciated that the process for training the click probability predicting model described above in conjunction with 8 is merely exemplary. Depending on actual application requirements, the steps in the process for training the click probability predicting model may be replaced or modified in any manner, and the process may comprise more or fewer steps. In addition, the specific order or hierarchy of the steps in the process 800 is merely exemplary, and the process for training the click probability predicting model may be performed in an order different from the described order.

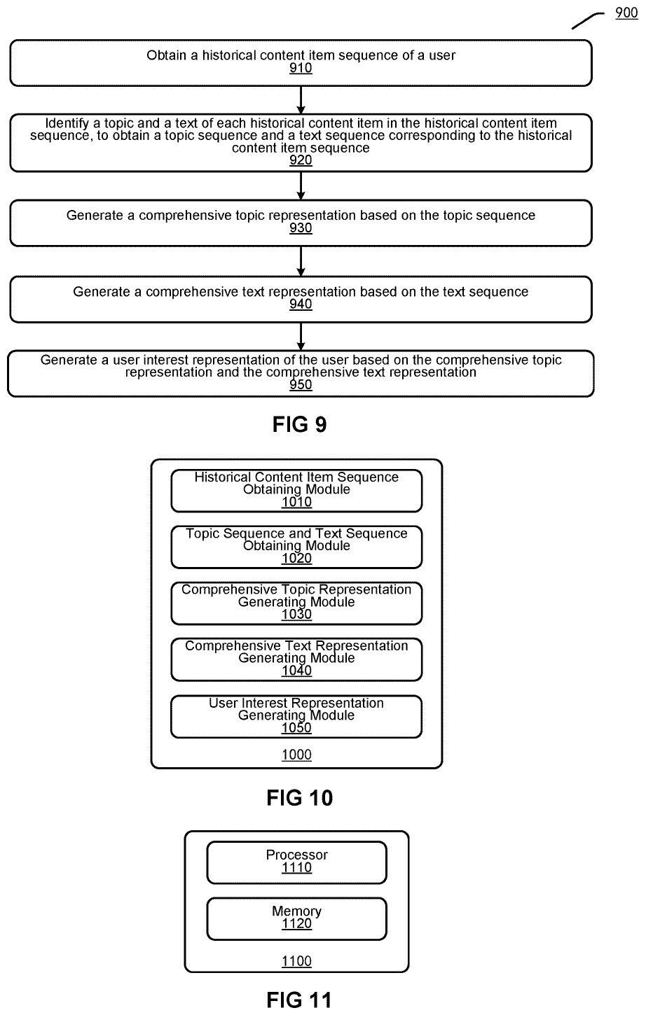

FIG. 9 is a flowchart of an exemplary method 900 for hierarchical representation learning of user interest according to an embodiment of the present disclosure.

At 910, a historical content item sequence of a user may be obtained.

At 920, a topic and a text of each historical content item in the historical content item sequence may be identified, to obtain a topic sequence and a text sequence corresponding to the historical content item sequence.

At 930, a comprehensive topic representation may be generated based on the topic sequence.

At 940, a comprehensive text representation may be generated based on the text sequence.

At 950, a user interest representation of the user may be generated based on the comprehensive topic representation and the comprehensive text representation.

In an implementation, the comprehensive topic representation and the comprehensive text representation may have different information abstraction levels.

In an implementation, the generating a comprehensive topic representation may comprise: generating a topic representation sequence corresponding to the topic sequence; construct a topic graph corresponding to the topic sequence; and generating the comprehensive topic representation based on the topic representation sequence and the topic graph.

The constructing a topic graph may comprise: determining a plurality of topic categories included in the topic sequence; setting the plurality of topic categories into a plurality of nodes; determining a set of edges among the plurality of nodes; and combining the plurality of nodes and the set of edges into the topic graph.

The determining a set of edges may comprise, for every two nodes in the plurality of nodes: determine whether there is a transition between two topic categories corresponding to the two nodes according to the topic sequence; in response to determining that there is a transition between the two topic categories, determining a transition direction of the transition and a number of transitions corresponding to the transition direction; and determining a direction and a number of edges existing between the two nodes based on the determined transition direction and the determined number of transitions.

The generating the comprehensive topic representation may comprise: deriving, from the topic graph, relation information representing relations among a plurality of nodes in the topic graph; and generating the comprehensive topic representation based on the topic representation sequence and the relation information.

The deriving relation information may comprise: acquiring graph edge information between every two nodes in the topic graph; counting a number of edges associated with each node in the topic graph; and deriving the relation information based on the graph edge information and the number.

In an implementation, the text may comprise at least one of a title, an abstract, and a body. The text sequence may comprise at least one of a title sequence, an abstract sequence, and a body sequence.

In an implementation, the generating a comprehensive text representation may comprise: generating a comprehensive text attention representation through an attention mechanism based on the text sequence. The generating a user interest representation may comprise: generating the user interest representation based on the comprehensive topic representation and the comprehensive text attention representation.

In an implementation, the generating a comprehensive text representation may comprise: generating a comprehensive text capsule representation using a capsule network based at least on the text sequence. The generating a user interest representation may comprise: generating the user interest representation based on the comprehensive topic representation and the comprehensive text capsule representation.

In an implementation, the generating a comprehensive text representation may comprise: generating a comprehensive text attention representation through an attention mechanism based on the text sequence; and generating a comprehensive text capsule representation using a capsule network based at least on the text sequence. The generating a user interest representation may comprise: generating the user interest representation based on the comprehensive topic representation, the comprehensive text attention representation, and the comprehensive text capsule representation.

The comprehensive text attention representation and the comprehensive text capsule representation may have different information abstraction levels.

The generating a comprehensive text capsule representation may comprise: generating an interest capsule representation using the capsule network based on the text sequence; generating a target content item representation of a target content item; and generating the comprehensive text capsule representation through an attention mechanism based on the interest capsule representation and the target content item representation.

The generating a target content item representation may comprise: extracting a text of the target content item; generating a text representation of the text; and generating the target content item representation through an attention mechanism based on the text representation.

In an implementation, the method 900 may further comprise: predicting a click probability of the user clicking a target content item based on the user interest representation and a target content item representation of the target content item.

The click probability may be output through a click probability predicting model. The training of the click probability predicting model may comprise: constructing a training dataset, the training dataset including a plurality of positive samples and a plurality of negative sample sets corresponding to the plurality of positive samples; generating a plurality of posterior click probabilities corresponding to the plurality of positive samples; generating a prediction loss based on the plurality of posterior click probabilities; and optimizing the click probability predicting model through minimizing the prediction loss.

The generating a plurality of posterior click probabilities may comprise, for each positive sample: predicting a click probability of the positive sample corresponding to the positive sample; for each negative sample in a negative sample set corresponding to the positive sample, predicting a negative sample click probability corresponding to the negative sample, to obtain a negative sample click probability set corresponding to the negative sample set; and calculating a posterior click probability corresponding to the positive sample based on the positive sample click probability and the negative sample click probability set.

In an implementation, the historical content item or the target content item may comprise at least one of news, music, movie, video, book, and product information.

It should be appreciated that the method 900 may further comprise any step/process for hierarchical representation learning of user interest according to the embodiments of the present disclosure as mentioned above.

FIG. 10 illustrates an exemplary apparatus 1000 for hierarchical representation learning of user interest according to an embodiment of the present disclosure.

The apparatus 1000 may comprise: a historical content item sequence obtaining module 1010, for obtaining a historical content item sequence of a user; a topic sequence and text sequence obtaining module 1020, for identifying a topic and a text of each historical content item in the historical content item sequence, to obtain a topic sequence and a text sequence corresponding to the historical content item sequence; a comprehensive topic representation generating module 1030, for generating a comprehensive topic representation based on the topic sequence; a comprehensive text representation generating module 1040, for generating a comprehensive text representation based on the text sequence; and an user interest representation generating module 1050, for generating a user interest representation of the user based on the comprehensive topic representation and the comprehensive text representation. Moreover, the apparatus 1000 may further comprise any other modules configured for hierarchical representation learning of user interest according to the embodiments of the present disclosure as mentioned above.

FIG. 11 illustrates an exemplary apparatus 1100 for hierarchical representation learning of user interest according to an embodiment of the present disclosure.

The apparatus 1100 may comprise at least one processor 1110 and a memory 1120 storing computer-executable instructions. The computer-executable instructions, when executed, may cause the at least one processor 1110 to: obtain a historical content item sequence of a user, identify a topic and a text of each historical content item in the historical content item sequence, to obtain a topic sequence and a text sequence corresponding to the historical content item sequence, generate a comprehensive topic representation based on the topic sequence, generate a comprehensive text representation based on the text sequence, and generate a user interest representation of the user based on the comprehensive topic representation and the comprehensive text representation.

It should be appreciated that the processor 1110 may further perform any other step/process of the methods for hierarchical representation learning of user interest according to the embodiments of the present disclosure as mentioned above.

The embodiments of the present disclosure propose a computer program product for hierarchical representation learning of user interest, comprising a computer program that is executed by at least one processor for: obtaining a historical content item sequence of a user; identifying a topic and a text of each historical content item in the historical content item sequence, to obtain a topic sequence and a text sequence corresponding to the historical content item sequence; generating a comprehensive topic representation based on the topic sequence; generating a comprehensive text representation based on the text sequence; and generating a user interest representation of the user based on the comprehensive topic representation and the comprehensive text representation.

Furthermore, the computer program may be further executed for implementing any other steps/processes of the methods for hierarchical representation learning of user interest according to the embodiments of the present disclosure as mentioned above.

The embodiments of the present disclosure may be embodied in a non-transitory computer-readable medium. The non-transitory computer-readable medium may comprise instructions that, when executed, cause one or more processors to perform any operations of the methods for hierarchical representation learning of user interest according to the embodiments of the present disclosure as mentioned above.

It should be appreciated that all the operations in the methods described above are merely exemplary, and the present disclosure is not limited to any operations in the methods or sequence orders of these operations, and should cover all other equivalents under the same or similar concepts. In addition, the articles “a” and “an” as used in this specification and the appended claims should generally be construed to mean “one” or “one or more” unless specified otherwise or clear from the context to be directed to a singular form.

It should also be appreciated that all the modules in the apparatuses described above may be implemented in various approaches. These modules may be implemented as hardware, software, or a combination thereof. Moreover, any of these modules may be further functionally divided into sub-modules or combined together.

Processors have been described in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in the present disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured for performing the various functions described throughout the present disclosure. The functionality of a processor, any portion of a processor, or any combination of processors presented in the present disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, threads of execution, procedures, functions, etc. The software may reside on a computer-readable medium. A computer-readable medium may include, by way of example, memory such as a magnetic storage device (e.g., hard disk, floppy disk, magnetic strip), an optical disk, a smart card, a flash memory device, random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout the present disclosure, the memory may be internal to the processors, e.g., cache or register.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein. All structural and functional equivalents to the elements of the various aspects described throughout the present disclosure that are known or later come to be known to those of ordinary skilled in the art are expressly incorporated herein and intended to be encompassed by the claims.

1. A method for hierarchical representation learning of user interest, comprising: obtaining a historical content item sequence of a user; identifying a topic and a text of each historical content item in the historical content item sequence, to obtain a topic sequence and a text sequence corresponding to the historical content item sequence; generating a comprehensive topic representation based on the topic sequence; generating a comprehensive text representation based on the text sequence; and generating a user interest representation of the user based on the comprehensive topic representation and the comprehensive text representation.

2. The method of claim 1, wherein the comprehensive topic representation and the comprehensive text representation have different information abstraction levels.

3. The method of claim 1, wherein the generating a comprehensive topic representation comprises: generating a topic representation sequence corresponding to the topic sequence; construct a topic graph corresponding to the topic sequence; and generating the comprehensive topic representation based on the topic representation sequence and the topic graph.

4. The method of claim 3, wherein the constructing a topic graph comprises: determining a plurality of topic categories included in the topic sequence; setting the plurality of topic categories into a plurality of nodes; determining a set of edges among the plurality of nodes; and combining the plurality of nodes and the set of edges into the topic graph.

5. The method of claim 4, wherein the determining a set of edges comprises, for every two nodes in the plurality of nodes: determine whether there is a transition between two topic categories corresponding to the two nodes according to the topic sequence; in response to determining that there is a transition between the two topic categories, determining a transition direction of the transition and a number of transitions corresponding to the transition direction; and determining a direction and a number of edges existing between the two nodes based on the determined transition direction and the determined number of transitions.

6. The method of claim 1, wherein the generating a comprehensive text representation comprises: generating a comprehensive text attention representation through an attention mechanism based on the text sequence, and the generating a user interest representation comprises: generating the user interest representation based on the comprehensive topic representation and the comprehensive text attention representation.

7. The method of claim 1, wherein the generating a comprehensive text representation comprises: generating a comprehensive text capsule representation using a capsule network based at least on the text sequence, and the generating a user interest representation comprises: generating the user interest representation based on the comprehensive topic representation and the comprehensive text capsule representation.

8. The method of claim 1, wherein the generating a comprehensive text representation comprises: generating a comprehensive text attention representation through an attention mechanism based on the text sequence; and generating a comprehensive text capsule representation using a capsule network based at least on the text sequence, and the generating a user interest representation comprises: generating the user interest representation based on the comprehensive topic representation, the comprehensive text attention representation, and the comprehensive text capsule representation.

9. The method of claim 8, wherein the comprehensive text attention representation and the comprehensive text capsule representation have different information abstraction levels.

10. The method of claim 7, wherein the generating a comprehensive text capsule representation comprises: generating an interest capsule representation using the capsule network based on the text sequence; generating a target content item representation of a target content item; and generating the comprehensive text capsule representation through an attention mechanism based on the interest capsule representation and the target content item representation.

11. The method of claim 1, further comprising: predicting a click probability of the user clicking a target content item based on the user interest representation and a target content item representation of the target content item.

12. The method of claim 11, wherein the click probability is output through a click probability predicting model, and a training of the click probability predicting model comprises: constructing a training dataset, the training dataset including a plurality of positive samples and a plurality of negative sample sets corresponding to the plurality of positive samples; generating a plurality of posterior click probabilities corresponding to the plurality of positive samples; generating a prediction loss based on the plurality of posterior click probabilities; and optimizing the click probability predicting model through minimizing the prediction loss.

13. The method of claim 12, wherein the generating a plurality of posterior click probabilities comprises, for each positive sample: predicting a click probability of the positive sample corresponding to the positive sample; for each negative sample in a negative sample set corresponding to the positive sample, predicting a negative sample click probability corresponding to the negative sample, to obtain a negative sample click probability set corresponding to the negative sample set; and calculating a posterior click probability corresponding to the positive sample based on the positive sample click probability and the negative sample click probability set.

14. An apparatus for hierarchical representation learning of user interest, comprising: at least one processor; and a memory storing computer-executable instructions that, when executed, cause the at least one processor to: obtain a historical content item sequence of a user, identify a topic and a text of each historical content item in the historical content item sequence, to obtain a topic sequence and a text sequence corresponding to the historical content item sequence, generate a comprehensive topic representation based on the topic sequence, generate a comprehensive text representation based on the text sequence, and generate a user interest representation of the user based on the comprehensive topic representation and the comprehensive text representation.

15. A computer program product for hierarchical representation learning of user interest, comprising a computer program that is executed by at least one processor for: obtaining a historical content item sequence of a user; identifying a topic and a text of each historical content item in the historical content item sequence, to obtain a topic sequence and a text sequence corresponding to the historical content item sequence; generating a comprehensive topic representation based on the topic sequence; generating a comprehensive text representation based on the text sequence; and generating a user interest representation of the user based on the comprehensive topic representation and the comprehensive text representation
